(19) United States
(12) Patent Application Publication
(10) Pub. No.: US 2016/0086477 A9
(43) Pub. Date: Mar. 24, 2016

(54) HVAC AIR FILTER CHECK REMINDER REFRIGERATOR MAGNET

(71) Applicants: Kent David Lyon, Cypress, TX (US); Jym Travis Daniel, Austin, TX (US)

(72) Inventors: Kent David Lyon, Cypress, TX (US); Jym Travis Daniel, Austin, TX (US)

(21) Appl. No.: 14/300,727

(22) Filed: Jun. 10, 2014

Related U.S. Application Data
(63) Continuation of application No. 13/295,023, filed on Nov. 11, 2011, now abandoned.

(51) Int. Cl. G08B 21/24

(52) U.S. Cl. CPC G08B 21/24

(57) ABSTRACT

An HVAC air filter check reminder refrigerator magnet easily attaches to top of mind locations within the home which visually and/or audibly alerts the user to check or change the HVAC air filter at the United States Department of Energy recommended lapse of time with a push of a single button.

### CROSS-REFERENCE TO RELATED APPLICATIONS

This application is a continuation application and claims priority to U.S. patent application Ser. No. 13/295,023 that was filed on Nov. 11, 2011.

### FIELD OF THE INVENTION

The invention relates generally to the field of electronic timing devices and more specifically to a heating, ventilating and air conditioning (HVAC) air filter check reminder refrigerator magnet.

### BACKGROUND OF THE INVENTION

Electronic timing devices are known and have been used for many years in various applications including; count down timers, interval timers, clocks, watches and the like. One type of activity that can benefit from a timing device is the checking of an HVAC air filter. Per the U.S. Department of Energy's Energy Star website “Change your air filter regularly, Check your filter every month, especially during heavy use months (winter and summer). If the filter looks dirty after a month, change it. At a minimum, change the filter every three months. A dirty filter will slow down air flow and make the system work harder to keep you warm or cool—wasting energy. A clean filter will also prevent dust and dirt from building up in the system—leading to expensive maintenance and/or early system failure.” yet studies have shown that 80% of all HVAC air filters are not changed at the appropriate time, thereby putting undue stress on the HVAC system and also the world's energy resources. Most people are aware of the above issues & additional significant costs but state that they just forget to change the air filter until they receive a large utility bill, only then they are committed to action.

Timing devices for reminding when to check an HVAC air filter have enjoyed very limited success for a myriad of reasons, some of which are discussed below.

Timing devices for reminding when to check a HVAC air filter are known in U.S. Pat. No. 7,621,978 (Johansson), for example, discloses a filter check reminder timer which is located adjacent to the air filter in the HVAC system and actuated by the piercing of the air filter frame and a piercing post moves to the aforementioned pierced position. This has several disadvantages such as having to pierce the air filter frame and being located in non-top of mind areas thereby requiring an audibled alert which can be annoying or maybe not even heard by the user. Another disadvantage is this device requires the user to access the air filter in order to turn off the alarm, which may not be convenient or easy to access.

U.S. Pat. No. 6,888,466 (Dermody) also discloses a filter check reminder timer which is included as part of the air filter or attached to an air filter and as such also has the disadvantages such as being located in non- top of mind areas thereby requiring an audibled alert which can be annoying or maybe not even heard by the user. And the disadvantage in that the device requires the user to access the air filter in order to turn off the alarm, which may not be convenient or easy to access.

U.S. Pat. No. 5,124,957 (Owens) discloses a programmable timing device for use in combination with an existing thermostat. This type of device has several disadvantages; it is not easily installed and it requires the user to program the alert.

Based on the foregoing, it is clear that although there have been HVAC air filter check reminder timer devices developed, none have been adopted widely due to the disadvantages discussed above. As such, there is a need for a simple to use, inexpensive, easy to install, and reliable device that is located in a top of mind area of the home which alerts and reminds the user that the United States Department of Energy and industry recommended time has lapsed and it is time to check or change the HVAC air filter.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings and abstract as a whole.

One advantage of at least one embodiment of the disclosed subject matter is to provide a simple to use, inexpensive, easy to install, and reliable device that alerts and reminds that the United States Department of Energy recommend time has lapsed and it is time to check or change the HVAC air filter.

An additional advantage of at least one embodiment of the disclosed subject matter is to provide a device that is simple to use and as such requires only one button to be pushed to set an alarm which is preset to warn when the United States Department of Energy recommend time has lapsed and it is time to check or change the HVAC air filter.

Yet another advantage of at least one embodiment of the disclosed subject matter is to provide a device which is easily attached to areas in the home where the alarm will easily be seen and remains top of mind.

Still another advantage of at least one embodiment of the disclosed subject matter is to provide a device that signals the user that it is time to check or change the air filter by an inexpensive method such as a light and/or an audible alarm.

Yet another advantage of at least one embodiment of the disclosed subject matter is to provide a device which is battery operated.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the claims. Additionally, any combination of one or more of the above advantages may be combined to form one or more embodiments and nothing should be interpreted as requiring all of the above.

### BRIEF DESCRIPTION OF THE DRAWING

At least some of the novel features believed characteristic of the invention are set forth in the claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 is a front perspective view of the of the HVAC air filter check reminder refrigerator magnet;

FIG. 2 is a rear perspective view of the of the HVAC air filter check reminder refrigerator magnet.

FIG. 3 is a side perspective view of the HVAC air filter check reminder refrigerator magnet.

### DETAILED DESCRIPTION OF THE INVENTION

When a new and clean air filter is placed in service in a HVAC system there is a United States Department of Energy recommended lapse of time of when an air filter should be checked and at a minimum, a lapse of time when an air filter should be changed; Currently the United States Department of Energy recommends that an air filter be checked every month and at a minimum, an air filter should be changed every three months.

As such, an exemplary embodiment is a mechanism which alerts the user to check the air filter for a clogged condition after one month with a push of a single button or alerts the user to change the air filter after three months has lapsed with a push of a single button.

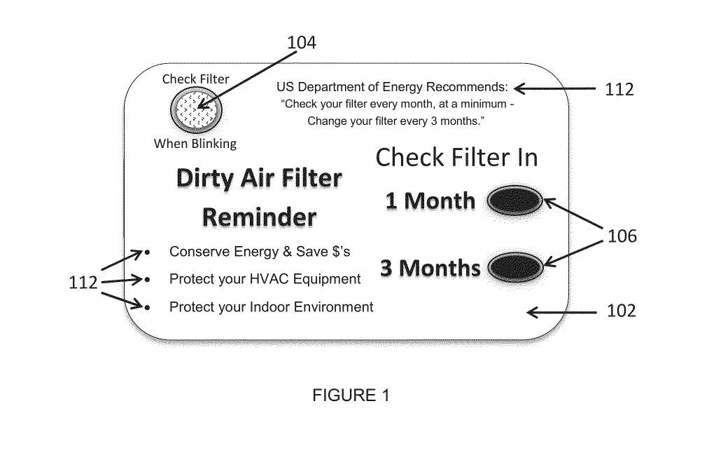

Referring now to the invention in more detail, FIG. 1 is a front perspective view of an exemplary embodiment of a HVAC air filter check reminder refrigerator magnet. The housing 102 in the preferred embodiment is the size and shape of a credit card, which is small enough to be acceptable as a refrigerator magnet but large enough to be effective in altering the user to check their air filter at the pre-determined time lapse. A light emitting diode 104 is located on the front panel of the housing 102 which lights up at the appropriate time, 30 days or 90 days depending on the selection made by the user, inside of the housing 102 is an electric sound emitting device which is also activated at the appropriate time, 30 days or 90 days depending on the selection made by the user. Also located on the front panel of the housing 102 is a plurality of timer start buttons 106. When a new and clean air filter is placed in service in a HVAC system the user is instructed to press the timer start button 106 which alerts them at their preferred time lapse. The timer start buttons 106 are pre-set to lapses of time as recommended by the United States Department of Energy. Currently the United States Department of Energy recommends that an HVAC air filter be checked every month and at a minimum changed every 3 months, as such, the current preferred embodiment has two timer start buttons 106, one for “one month” and one for “three months”. The housing 102 also includes pre-printed messages 112 that remind the user of the importance of changing the air filter regularly and the current time recommendations made by the US Department of Energy.

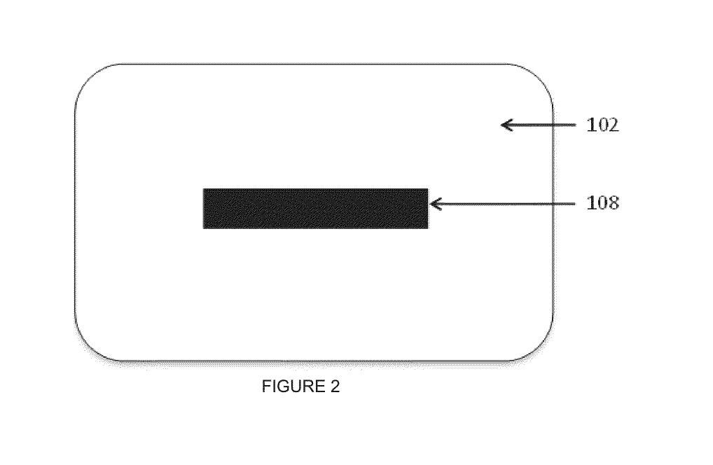

FIG. 2 is a rear perspective view of an exemplary embodiment of a HVAC air filter check reminder refrigerator magnet with a magnet 108 located within the housing 102 easily attaches the HVAC air filter check reminder refrigerator magnet to areas in the home where the alarm will easily be seen and remains top of mind such as the refrigerator door.

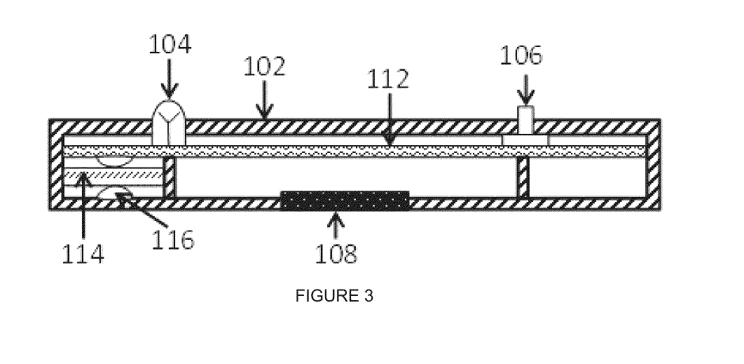

FIG. 3 is a side sectional view of an exemplary embodiment of a HVAC air filter check reminder refrigerator magnet with a battery 114 which is between two battery contacts 116, one of which is connected to the housing 102 and the other is connected to the circuit board. The battery provides electrical current to the light emitting device and the functions of the circuit board 112 which is also regulated by the timer start buttons 106 as described above. A magnet 108 located within the housing 102 easily attaches the HVAC air filter check reminder refrigerator magnet to areas in the home where the alarm will easily be seen and remains top of mind such as the refrigerator door.

What is claimed is:

1. A heating, ventilating, and air conditioning reminder comprising,
a housing having an alerting device, at least one start button, and a timing circuit;
wherein the housing is affixed directly to a surface;
wherein the start button controls the timing circuit, and
wherein the timing circuit controls the alerting device.

2. The heating, ventilating, and air conditioning reminder of claim 1 wherein the alerting device is a light emitting diode.

3. The heating, ventilating, and air conditioning reminder of claim 1 wherein the alerting device is a sound emitting device.

4. The heating, ventilating, and air conditioning reminder of claim 1 wherein the surface is a wall.

5. The heating, ventilating, and air conditioning reminder of claim 4 wherein the housing is affixed by an adhesive.

6. The heating, ventilating, and air conditioning reminder of claim 1 wherein the surface is a refrigerator.

7. The heating, ventilating, and air conditioning reminder of claim 6 wherein the housing is affixed to the refrigerator by a magnet.

8. The heating, ventilating, and air conditioning reminder of claim 1 wherein the timing circuit is preset for a single period of time.

9. The heating, ventilating, and air conditioning reminder of claim 8 wherein the single period of time is thirty days.

10. The heating, ventilating, and air conditioning reminder of claim 8 wherein the single period of time is sixty days.

11. The heating, ventilating, and air conditioning reminder of claim 8 wherein the single period of time is ninety days.

12. The heating, ventilating, and air conditioning reminder of claim 8 wherein the single period of time is one month.

13. A method of using a heating, ventilating, and air conditioning reminder comprising,
removably attaching a housing directly to a surface;
pressing a start button to select a single preset period of time;
counting down the single preset period of time; and
activating an alert at the end of the preselected period of time.

14. The method of using a heating, ventilating, and air conditioning reminder of claim 13 wherein the surface is an appliance.

15. The method of using a heating, ventilating, and air conditioning reminder of claim 14 wherein the housing is removably attached to the appliance by a magnet.

16. The method of using a heating, ventilating, and air conditioning reminder of claim 13 wherein the surface is a wall.

17. The method of using a heating, ventilating, and air conditioning reminder of claim 16 wherein the housing is removably attached to the wall by an adhesive.

18. The method of using a heating, ventilating, and air conditioning reminder of claim 13 wherein the single preset period of time is one month.

19. The method of using a heating, ventilating, and air conditioning reminder of claim 13 wherein the single preset period of time is thirty days.

20. The method of using a heating, ventilating, and air conditioning reminder of claim 13 wherein the single preset period of time is ninety days.
